(19) United States
(12) Patent Application Publication
(10) Pub. No.: US 2006/0207164 A1
(43) Pub. Date: Sep. 21, 2006

(54) Termite monitoring and bait station

(76) Inventor: David Pearson, Acacia Ridge (AU)

Correspondence Address: HUDAK, SHUNK & FARINE, CO., L.P.A., 2020 FRONT STREET, SUITE 307, CUYAHOGA FALLS, OH, 44221, US

(21) Appl. No.: 11/385,208

(22) Filed: Mar. 21, 2006

(30) Foreign Application Priority Data
Mar. 21, 2005 (AU) 2005901365

(51) Int. Cl. A01M 17/00; A01M 1/20

(52) U.S. Cl. 43/132.1; 43/131

(57) ABSTRACT

A termite monitoring and baiting station (10) has a housing (20), with a removable cover (30), defining a cavity (24) to receive one or more pieces of termite attractant material (50), eg., mountain ash. The termite attractant material (50) may partially extend outwardly through holes (26,28) in the side wall (21) of the container (20) and has grooves (53) to increase the effective surface area and to provide tracks for the termites. When termite activity is noted, a termite toxicant bait (60) is placed in the cavity (24), to enable the termites to carry the bait material (62) back to their colonies.

### BACKGROUND OF THE INVENTION

1. field of the Invention THIS INVENTION relates to a termite monitoring station. The invention also relates to a termite monitoring station in which bait may be inserted to suppress or eradicate colonies of termites.

2. Prior Art

Termites cause billions of dollars damage to objects such as building structures, agricultural crops and trees around the world.

For many years, termite control relied upon the use of environmentally-persistent pesticides at points of possible termite entry and attack. However, in recent years, environmental concerns about the pesticides used have resulted in the proscribing of such pesticides, at least in developed countries.

One viable low-impact solution has been the adoption of termite baiting, where the termites are aggregated at a fixed point and are eliminated due to their consumption of a toxicant-containing bait placed at the point of aggregation.

However, as the baits are expensive and still have some environmental concerns in their handling and persistence, not all possible aggregation points for the termites should be baited.

The first step is to establish where the termites are aggregating, before the introduction of the termite bait.

### SUMMARY OF THE PRESENT INVENTION

It is an object of the present invention to provide an inground termite monitoring station which is easy to install and easy to operate.

It is a preferred object to provide such a monitoring station which is relatively simple and inexpensive to manufacture.

It is a further preferred object of the present invention to provide such a monitoring station which is attractive to the termites to encourage their ingress into the station.

It is a further preferred object of the present invention to provide such a station where, when termites have been found to aggregate in the monitoring station, that bait can easily be introduced with minimal disturbance.

Other preferred objects of the present invention will become apparent from the following description.

In one aspect, the present invention resides in a termite monitoring station, including:

a rigid housing, having at least a side wall and bottom wall formed of (preferably) termite resistant material, forming a cavity to contain a termite attractant material;

a removable cover to provide access to the cavity;

at least one termite attractant material in the cavity; and

a plurality of holes in at least the side wall, and optionally the bottom wall, of the housing, to enable the termites to gain access to the termite attractant material in the cavity.

The rigid housing is preferably formed of plastics material and the side wall is preferably frusto-conical or cylindrical and the bottom wall is preferably circular.

Preferably, a circumferential flange is provided around an upper end of the side wall. Preferably, the circumferential flange incorporates downwardly-directed bracing flanges, the circumferential flange and bracing flanges preferably providing a non-rotatable location of the housing in a hole in soil in which the termite monitoring station is placed.

Preferably, the removable cover has locking flanges engageable with complementary flanges on a top face of the circumferential flange to form a releasable bayonet connection between the housing and the removable cover.

The removable cover is preferably lockably engaged with, or released from, the housing by a tool having spigots or pins operable to engage the locking flanges on the cover.

Preferably, the termite attractant material is one or more pieces of timber or other cellulose-based material. One particularly suitable material for attracting Australian termites is mountain ash timber.

Preferably, the or each piece of termite-attractant material has one or more vertical grooves or slots formed therein to form tracks for the termites (and to increase the surface area of the attractant material).

Preferably, the holes in the side wall are of least two or more different widths and preferably extend substantially the full height of the termite attractant material. Where the side wall is substantially frusto-conical, the termite attractant material may extend at least partially outwardly through the holes.

Holes for the access of the termites may also be provided in the bottom wall.

Preferably, the outer face of the side wall is provided with vertical grooves which provides tracks towards the holes for the termites to follow.

In a second aspect, the present invention resides in a termite baiting station including:

the termite monitoring station as hereinbefore described; and

at least one termite toxicant material in the cavity, above the termite attractant material.

Examples of suitable bait materials are chlorfluazuron and hexflumuron. The actual choice of bait material will be dependent on the species of termites being monitored/killed.

### BRIEF DESCRIPTION OF THE DRAWINGS

To enable the invention to be fully understood, a preferred embodiment will now be described with reference to the accompanying drawings, in which:

FIG. 1 is an “exploded” perspective view of the housing, removable cover and cover removal tool;

FIG. 2 is an “exploded” perspective view of the housing and the termite attractant material;

FIG. 3 is a perspective view of the termite attractant material; and

FIG. 4 is an end view of one of the pieces of the termite attractant material.

### DETAILED DESCRIPTION OF THE PREFERRED EMBODIMENTS

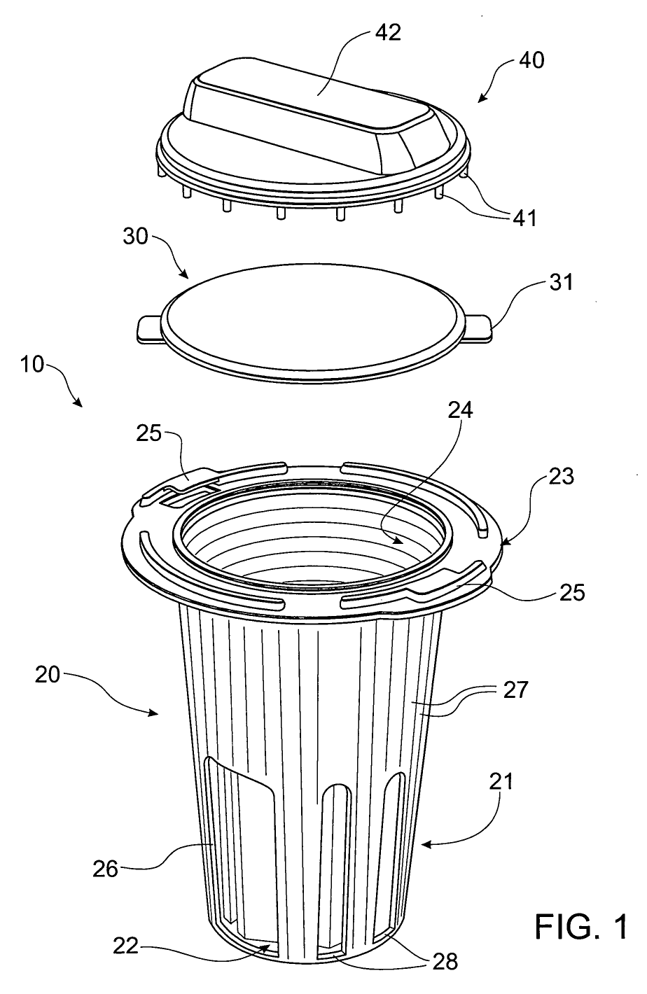

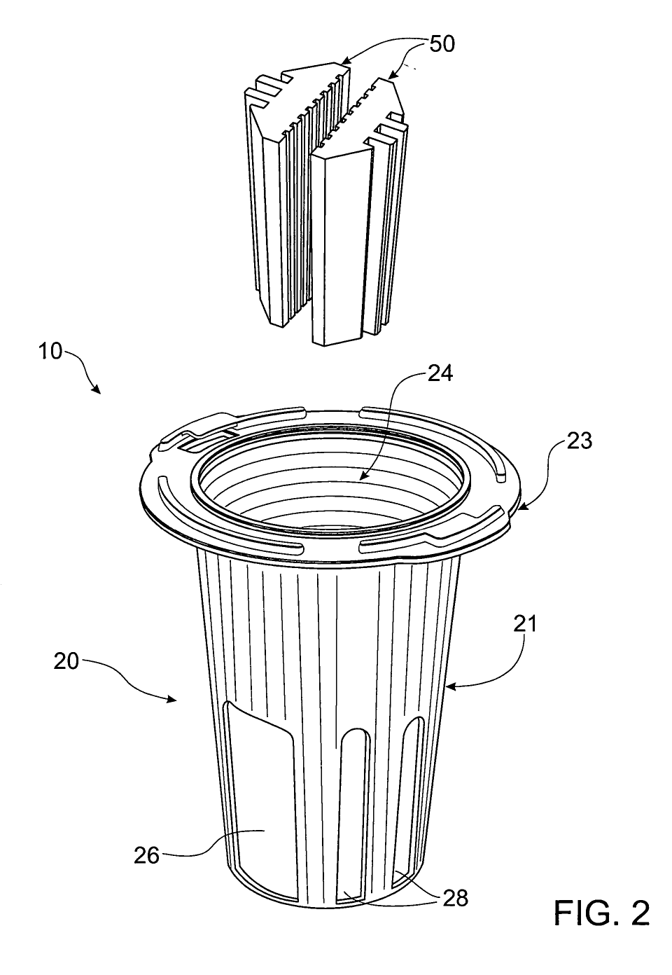

Referring to FIGS. 1 and 2, the termite monitoring station 10 has a housing 20, eg., injection moulded from plastics material, which is preferably termite-resistant.

The housing 20 has a frusto-conical side wall 21 (which is downwardly-convergent) and a bottom wall 22 (which may be provided with one or more holes, not shown).

A circumferential flange 23 is provided around the open “mouth” of the cavity 24 within the housing 20. A number of substantially vertical bracing flanges (not shown) may interconnect the circumferential flange 23 and the sidewall 21 to ensure stable, non-rotational, location of the housing 20 in a suitable hole formed in the soil (not shown).

A removable cover 30, also of plastics material, has a pair of diametrically-opposed locking flanges 31 for releasable engagement with complementary flanges 25, on the upper face of the circumferential flange 23, to provide a releasable bayonet-type connection between the removable cover 30 and the housing 20.

A tool 40 has a circular body with a plurality of downwardly-directed pins 41 at spaced locations around the underside of the periphery of the body 40 and a hand grip 42 on the upper side of the body 40. The pins 41 are spaced so that a pair of the pins 41 will releasably engage a respective locking flange 31 on the removable cover 30, and the hand grip 42 enables the tool 40 to rotate the removable cover 30 into, or out of, locking engagement with the housing 20.

Holes 26, 28 of different widths are provided in the side wall 21 of the housing 20 and extend substantially to the height of the termite attractant material 50 placed in the cavity 24.

Substantially vertical grooves 27 are provided on the outer face of the side wall 21 to provide tracks to encourage termites towards the holes 26, 28.

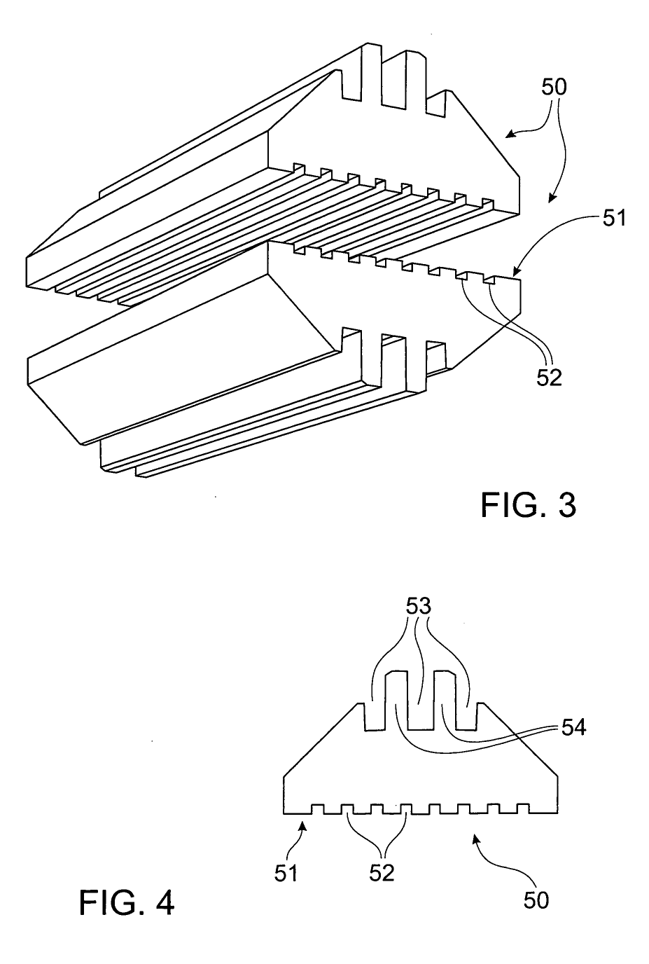

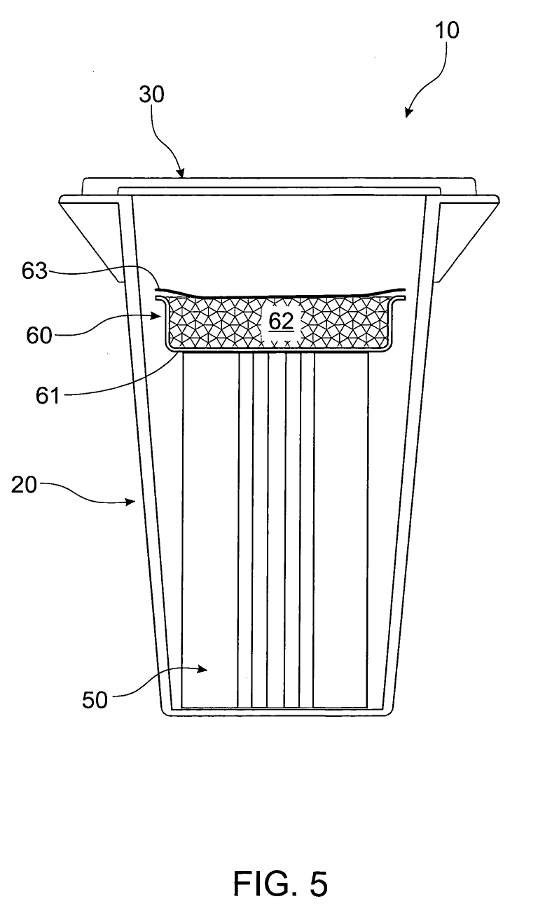

Referring to FIGS. 2 to 4, the termite attractant material 50 comprises two pieces of timber, eg., mountain ash, of substantially triangular profile so that the two pieces 50 can be placed “back-to-back” in the cavity 24.

Each piece of the termite attractant material 50 has a “base” wall 51 provided with a plurality of grooves or slots 52.

The “apex” of each piece 50 is provided with three slots 53 separated by spaced flanges 54.

The slots or grooves 52, 53 both increase the effective surface area of the termite attractant material 50 and also provide tracks to encourage the termites to enter the housing 20 and move up into the cavity 24.

In addition, the flanges 54 on the termite attractant material 50 may at least partially extend outwardly through the larger slots 26 in the side wall 21 to assist in encouraging the termites to enter the termite monitoring station 10.

In use, a hole is dug in the soil and the housing 20 is then placed in the soil with the circumferential flange 23 at ground level. The termite attractant material 50 is placed in the housing 20 and the housing 20 is closed by the removable cap 30.

At selective periods, eg., every two days/weeks/fortnights/months, depending on the possible degree of termite infestation in the area, the operator uses the tool 40 to carefully release the removable cover 30 from the housing 20 and inspects the cavity 24 for any signs of termite infestation. If no termites are noted, the removable cover 30 is carefully replaced and the station 10 re-checked at the next scheduled period.

If termites are noted in the cavity 24, a suitable termite toxicant bait 60, eg., containing chlorfluazuron may be placed within the cavity 24, without disturbing the termites therein, and the removable cover 30 is replaced.

The toxicant bait 60, containing a bait material 62, has a plastic container (or dish) 61 with a removable plastics- or metal-foil cover 63 adhered, or heat- or RF-welded to the rim of the container 61. Alternatively, the toxicant bait 60 has the bait material 62 contained in a tamper-evident bag which may be slit open to enable the termites to access the bait material 62.

The bait material 62 will be selected to be effective against the species of termites in the local vicinity; and, typically, 100 gm of bait material 62 will be provided for access to the termites.

The bait material 62 may include chlorfluazuron (eg., at 1 gm/Kg) or hexaflumuron (eg., at 5 gm/Kg), to which, eg., 50 ml water has been added.

The toxicant bait 60 is arranged so there is no human contact with the bait material, no contamination thereof and no spillage.

The termites prefer a warm, humid, climate and it is preferable that the removable cap 30 be coloured black (or a dark colour) to draw heat into the cavity 24; and distilled water may be placed on the termite attractant material 50, prior to, or at the time of, insertion, to increase the humidity within the cavity 24.

The choice of the termite attractant material 50 will be dependent upon the species of termite to be monitored, but tests have established that mountain ash timber is the most palatable to many species of Australian termites.

Where the unit 10 is to be used solely as a monitoring unit, the blocks of termite attractant material 50 can be double-stacked to increase the time between inspection of the monitoring unit 10. (The monitoring unit must be inspected regularly enough that the termites will not eat all the termite-attractant material 50 and leave the monitoring unit 10 before the next inspection.) Where the monitoring unit 10 is provided with double stacked blocks of the termite attractant material 50, the normal inspection period will typically be 8-12 weeks.

The requirement for the tool 40, to remove the removable cover 30, will minimise the likelihood of tampering with the unit 10. Any attempt at tampering may be indicated by disturbance of the soil around the unit 10.

The very large surface area of the termite attractant material 50, and the large holes 26, 28, will encourage the termites in the vicinity of the unit 10 to aggregate therein.

The grooves 27 on the side wall 21 of the housing, and the grooves 52, 53 in the termite attractant material; encourage the termites into the station 10, as termites are blind and tend to follow tracks.

The solid side wall 21 of the housing about the level of the holes 26, 28, and the black-coloured removable cover 30, assist in maintaining a hot/humid zone in the cavity 24 above the termite attractant material 50, particularly after that material has been wetted, to encourage the termites to enter into, and aggregate in, the cavity 24.

It will be readily apparent to the skilled addressee that various changes and modifications may be made to the preferred embodiment without departing from the present invention.

I claim:

1. A termite monitoring station, including:
a rigid housing, having at least a side wall and bottom wall formed of termite resistant material, forming a cavity to contain a termite attractant material;
a removable cover to provide access to the cavity;
at least one termite attractant material in the cavity; and
a plurality of holes in at least the side wall, and optionally the bottom wall, of the housing, to enable the termites to gain access to the termite attractant material in the cavity.

2. A station as claimed in claim 1, wherein:
the rigid housing is formed of plastics material;
the side wall is frusto-conical or cylindrical; and
the bottom wall is preferably circular.

3. A termite station as claimed in claim 2, wherein:
a circumferential flange is provided around an upper end of the side wall, and the circumferential flange incorporates downwardly-directed bracing flanges; and
the circumferential flange and bracing flanges providing a non-rotatable location of the housing in a hole in soil in which the termite monitoring station is placed.

4. A station as claimed in claim 3, wherein:
the removable cover has locking flanges engageable with complementary flanges on a top face of the circumferential flange to form a releasable bayonet connection between the housing and the removable cover.

5. A station as claimed in claim 4, wherein:
the removable cover is lockably engaged with, or released from, the housing by a tool having spigots or pins operable to engage the locking flanges on the cover.

6. A station as claimed in claim 1, wherein:
the termite attractant material is one or more pieces of timber or other cellulose-based material such as mountain ash timber.

7. A station as claimed in claim 6, wherein:
the or each piece of termite-attractant material has one or more vertical grooves or slots formed therein to form tracks for the termites and to increase the surface area of the attractant material.

8. A station as claimed in claim 2, wherein:
the holes in the side wall are of least two or more different widths and extend substantially the full height of the termite attractant material; and
when the side wall is substantially frusto-conical, the termite attractant material extends at least partially outwardly through the holes.

9. A station as claimed in claim 1, wherein:
holes for the access of the termites are also provided in the bottom wall.

10. A station as claimed in claim 1, wherein:
an outer face of the side wall is provided with vertical grooves which provides tracks towards the holes for the termites to follow.

11. A termite baiting station including:
the termite monitoring station as claimed in claim 1; and
at least one termite toxicant material in the cavity, above the termite attractant material.

12. A station as claimed in claim 11, wherein:
the toxicant materials include chlorfluazuron and hexflumuron.
